(19) United States
(12) Patent Application Publication
(10) Pub. No.: US 2024/0343482 A1
(43) Pub. Date: Oct. 17, 2024

(54) CYLINDER CONNECTION SYSTEM

(71) Applicant: Oshkosh Corporation, Oshkosh, WI (US)

(72) Inventors: Ross Turner, Oshkosh, WI (US); Derek Wente, Austin, MN (US); Joe Nelson, Oshkosh, WI (US)

(73) Assignee: Oshkosh Corporation, Oshkosh, WI (US)

(21) Appl. No.: 18/634,346

(22) Filed: Apr. 12, 2024

Related U.S. Application Data
(60) Provisional application No. 63/459,479, filed on Apr. 14, 2023.

(51) Int. Cl. B65F 3/10; B65F 3/04

(52) U.S. Cl. CPC B65F 3/10; B65F 3/046

(57) ABSTRACT

A hydraulic system includes a support structure, a hydraulic actuator, a rigid tube, a flexible tube, and a fluid port. At least a portion of the hydraulic actuator is movable between a retracted orientation and an extended orientation relative to the support structure. A first rigid tube end of the rigid tube is coupled to the hydraulic actuator. A second flexible tube end is coupled to a second rigid tube end of the rigid tube. The fluid port is coupled to the support structure so that the rigid tube moves relative to the fluid port between the retracted orientation and the extended orientation. The fluid port is coupled to the second flexible tube end so that the second rigid tube end and the fluid port are disposed along the same reference plane when the hydraulic actuator is in both the retracted orientation and the extended orientation.

### CROSS-REFERENCE TO RELATED PATENT APPLICATIONS

The present application claims the benefit of and priority to U.S. Provisional Application No. 63/459,479, filed Apr. 14, 2023, the entire contents of which are hereby incorporated by reference herein.

### BACKGROUND

The present disclosure relates generally to fluid circuits and hydraulic connections for refuse vehicles.

### SUMMARY

One exemplary embodiment relates to a hydraulic system that includes a support structure, a hydraulic actuator, a rigid tube, a flexible tube, and a fluid port. At least a portion of the hydraulic actuator is movable between a retracted orientation and an extended orientation. The rigid tube extends from a first rigid tube end to a second rigid tube end. The first rigid tube end is coupled to the hydraulic actuator. The flexible tube extends from a first flexible tube end to a second flexible tube end. The second flexible tube end is coupled to the rigid tube at the second rigid tube end. The fluid port is coupled to the support structure so that the rigid tube moves relative to the fluid port between the retracted orientation and the extended orientation. The fluid port is coupled to the second flexible tube end so that the second rigid tube end and the fluid port are disposed along the same reference plane when the hydraulic actuator is in both the retracted orientation and the extended orientation.

Another exemplary embodiment relates to a refuse vehicle that includes a body, a device, a hydraulic actuator, a rigid tube, and a flexible tube. The body defines a refuse container. The device is coupled to the body. The hydraulic actuator is coupled to the device and is configured to move the device relative to the refuse container between a retracted position and an extended position. The flexible tube extends from the rigid tube to a fluid port on the body. The rigid tube is arranged to support the flexible tube so that the flexible tube extends substantially along the same reference plane as the device moves from the retracted position to the extended position.

Still another exemplary embodiment relates to a method, such as a method of manufacturing a hydraulic system. The method includes (i) coupling a first tube end of a rigid tube to a hydraulic actuator that is configured to move relative to a support structure between a retracted orientation and an extended orientation; (ii) coupling a first flexible tube end of a flexible tube to a second rigid tube end of the rigid tube, and (iii) coupling a second flexible tube end of the flexible tube to a fluid port that is coupled to the support structure so that the rigid tube moves relative to the fluid port between the retracted orientation and the extended orientation, and so that the second rigid tube end and the fluid port are disposed along the same reference plane when the hydraulic actuator is in both the retracted orientation and the extended orientation.

Still another exemplary embodiment relates to a hydraulic system. The hydraulic system includes a hydraulic cylinder extending along a first axis between a first hydraulic cylinder end and a second hydraulic cylinder end, the hydraulic cylinder configured to transform between a retracted orientation and an extended orientation, the hydraulic cylinder including an input port proximate the first hydraulic cylinder end, a rigid tube extending from a first rigid tube end to a second rigid tube end, the first rigid tube end coupled to the hydraulic cylinder proximate the first hydraulic cylinder end and in fluid communication with the input port, a flexible tube extending from a first flexible tube end to a second flexible tube end, the second flexible tube end being coupled to the rigid tube proximate the second rigid tube end such that the flexible tube is in fluid communication with the rigid tube, and a fluid input coupled to the first flexible tube end and in fluid communication with the flexible tube such that the fluid input is configured to provide fluid to the hydraulic cylinder, wherein a first plane is intersected by the second rigid tube end and the fluid input while the hydraulic cylinder in the retracted orientation, and the first plane is intersected by the second rigid tube end and the fluid input while the hydraulic cylinder in the extended orientation.

According to various embodiments, the first plane is parallel to the first axis. According to various embodiments, the flexible tube is configured to substantially remain within the first plane as the hydraulic cylinder transforms from the retracted orientation to the extended orientation. According to various embodiments, a distance between the second rigid tube end and the fluid input changes as the hydraulic cylinder extends from the retracted orientation to the extended orientation. According to various embodiments, a first distance between the second rigid tube end and the fluid input is defined while the hydraulic cylinder in the retracted orientation and a second distance between the second rigid tube end and the fluid input is defined while the hydraulic cylinder in the extended orientation, the second distance being different from the first distance. According to various embodiments, the second distance is greater than the first distance. According to various embodiments, the hydraulic system further includes a first rigid support coupled to at least one of the rigid tube or the flexible tube proximate the second rigid tube end and a first rigid structure coupled to the first rigid support such that at least one of the rigid tube or the flexible tube is coupled to the first rigid structure. According to various embodiments, the hydraulic system further includes a second rigid support coupled to the flexible tube proximate the first flexible tube end and a second rigid structure coupled to the second rigid support such that the flexible tube is coupled to the second rigid structure.

According to various embodiments, the hydraulic cylinder is a first hydraulic cylinder, the rigid tube is a first rigid tube, the flexible tube is a first flexible tube, and the fluid input is a first fluid input and the hydraulic system further includes a second hydraulic cylinder extending along a second axis between a third hydraulic cylinder end and a fourth hydraulic cylinder end, the second hydraulic cylinder configured to transform between a retracted orientation and an extended orientation, the hydraulic cylinder including a second input port proximate the third hydraulic cylinder end, a second rigid tube extending from a third rigid tube end to a fourth rigid tube end, the third rigid tube end coupled to the second hydraulic cylinder proximate the third hydraulic cylinder end and in fluid communication with the second input port, a second flexible tube extending from a third flexible tube end to a fourth flexible tube end, the fourth flexible tube end being coupled to the second rigid tube proximate the fourth rigid tube end such that the second flexible tube is in fluid communication with the second rigid tube, and a second fluid input coupled to the third flexible tube end and in fluid communication with the second flexible tube such that the second fluid input is configured to provide fluid to the second hydraulic cylinder, wherein a second plane is intersected by the fourth rigid tube end and the second fluid input while the second hydraulic cylinder in the retracted orientation, and the second plane is intersected by the fourth rigid tube end and the second fluid input while the second hydraulic cylinder in the extended orientation. According to various embodiments, the second plane is parallel to the first plane. According to various embodiments, the hydraulic cylinder is configured to drive one or more components of a refuse vehicle.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a refuse vehicle, according to an embodiment;

FIG. 2 is a side perspective view of a hydraulic system of a refuse vehicle, according to an embodiment;

FIG. 3 is a side partial view of the hydraulic system of FIG. 2;

FIG. 4 is a top perspective view of the hydraulic system of FIG. 2; and

FIG. 5 is a flow diagram of a method of manufacturing a hydraulic system, according to an embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Hydraulic systems pressurize fluids or liquids (e.g., hydraulic fluid) to generate mechanical movement. For example, a hydraulic actuator (e.g., a hydraulic cylinder, etc.) may include a piston rod positioned within a body of the cylinder. The body defines an inner volume that is configured to receive pressurized fluid from a pump. The pump receives fluid from a fluid reservoir and pumps pressured fluid into the hydraulic cylinder. As the pressurized fluid is pumped into the inner volume of the pressurized cylinder, the piston rod translates relative to the body of the hydraulic cylinder. The piston rod may be coupled to one or more pieces of equipment (e.g., devices, etc.) to actuate the equipment.

In various embodiments, the hydraulic cylinder is configured to move (e.g., actuate, transform, etc.) between a retracted orientation (e.g., a retracted position, a first position, etc.) to an extended orientation (e.g., an extended position, a second position, etc.). For example, the piston rod may move relative to the body of the hydraulic cylinder as the hydraulic cylinder moves from the retracted orientation to the extended orientation. The piston rod may drive a piece of equipment (e.g., an ejector of a refuse vehicle, etc.) such that actuating the hydraulic cylinder from the retracted orientation to the extended orientation moves (e.g., actuates, etc.) the piece of equipment.

According to various embodiments, at least a portion of the hydraulic cylinder (e.g., the piston rod, the body, etc.) moves relative to one or more components of the hydraulic system as the hydraulic cylinder moves from the retracted orientation to the extended orientation. For example, a portion of the hydraulic cylinder may move relative to the pump and/or a fluid reservoir that provides hydraulic fluid to the pump that drives the hydraulic cylinder. In this example embodiment, a flexible tube may couple the hydraulic cylinder to the pump and/or a fluid reservoir such that hydraulic fluid is supplied to the inner volume of the hydraulic cylinder via the flexible hose. For example, the flexible tube may be in fluid communication with fluid port of the hydraulic cylinder that is in fluid communication with the inner volume. The flexible tube may be sized so that there is slack in the retracted orientation, and so that the flexible tube remains coupled to the hydraulic cylinder and the pump and/or a fluid reservoir as the hydraulic cylinder is actuated from the retracted orientation to the extended orientation. Without this additional length, the flexible tube may be pulled away and/or decoupled from the pump and/or fluid reservoir as the hydraulic cylinder is actuated.

According to various embodiments discussed herein, a hydraulic system includes rigid tube extending from a first rigid tube end to a second rigid tube end. The first rigid tube end is coupled to a cylinder port of the hydraulic cylinder. The second rigid tube end is coupled to the flexible tube. The flexible tube extends from a first flexible tube end to a second flexible tube end that is coupled to the second rigid tube end. The first flexible tube end is in fluid communication with a fluid port that is fixedly coupled to the vehicle body and that is configured to move relative to the rigid tube between the retracted orientation and the extended orientation. The fluid port may include, or be fluidly coupled to, the pump, the fluid reservoir, or a tube in fluid communication with the pump and/or the fluid reservoir.

According to various embodiments, the distance between the fluid input and the second rigid tube end changes as the hydraulic cylinder moves between the retracted orientation and the extended orientation. A slack flexible tube positioned between the fluid port and the second rigid tube end enables the distance between the fluid input and the second rigid tube end to change while the fluid input and the second rigid tube end remain in fluid communication.

According to various embodiments, the rigid tube extends away from the hydraulic cylinder, and supports the flexible tube relative to the fluid port so that the fluid port and the second rigid tube end are disposed along (e.g., intersect, etc.) the same reference plane when the hydraulic cylinder is in both the retracted orientation and the extended orientation. Further, the flexible tube may substantially remain in the same reference plane as the hydraulic cylinder moves between the retracted orientation and the extended orientation (e.g., from the retracted orientation to the extended orientation, etc.), so that any point along a centerline of the flexible tube is maintained substantially along a single, fixed reference plane as the hydraulic cylinder moves from the retracted orientation to the extended orientation, and vice versa. Maintaining flexible tube and flexible tube connections along a single plane (e.g., planar flexible tube connections, etc.) can prevent fittings and/or connectors from loosening, thereby reducing the risk of leaks.

According to various embodiments, keeping the flexible tube, the second rigid tube end, and/or the fluid port in the same plane as the hydraulic cylinder moves between the retracted orientation and the extended orientation may also reduce off-axis forces experienced at the connecting points between the flexible tube, the second rigid tube end, and/or the fluid input, and may also reduce forces acting on the flexible tube during movement of the hydraulic cylinder, which can reduce the likelihood of leaks proximate the connecting points. Such an arrangement can also increase the service life of the flexible tubes.

Referring to the figures generally, refuse vehicles collect a wide variety of waste, trash, and other material from residences and businesses. Operators of the refuse vehicle transport the material from various waste receptacles within a municipality to a storage or processing facility (e.g., a landfill, an incineration facility, a recycling facility, etc.). The material from these waste receptacles is stored within the refuse container of the refuse vehicle. The refuse container includes a compactor to compact the material within the refuse container. The refuse vehicle may include a lifting device configured to lift a refuse container. The refuse vehicle may include an eject device configured to eject refuse from the refuse container, and/or to compact refuse within the refuse vehicle. According to various embodiments, one or more of the mechanisms or devices may be driven, at least partially, using hydraulic power.

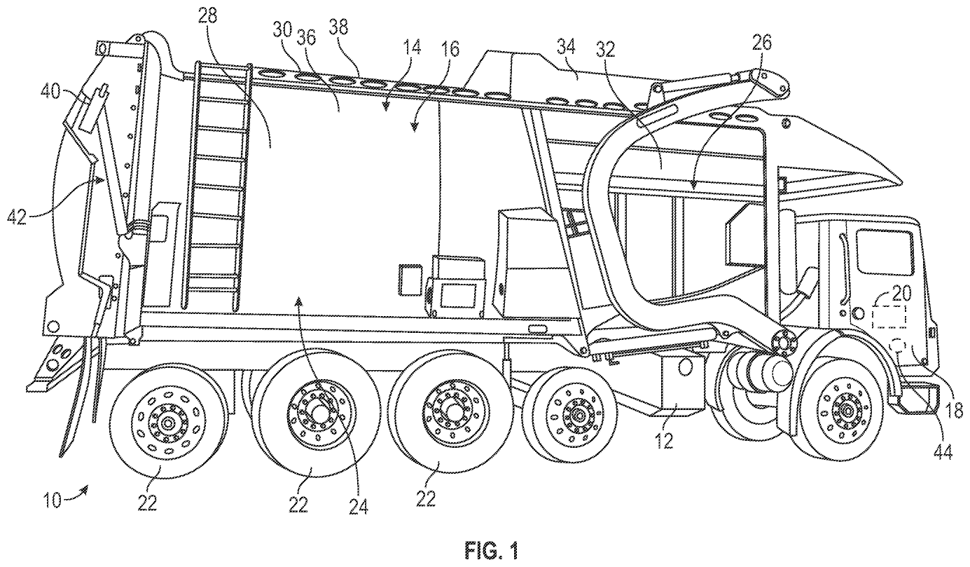

Referring to FIG. 1, a vehicle, shown as refuse vehicle 10 (e.g., garbage truck, waste collection truck, sanitation truck, etc.), includes a chassis, shown as a frame 12, and a body assembly, shown as body 14, coupled to the frame 12. The body 14 defines an on-board refuse container 16 and a cab 18. The cab 18 is coupled to a front end of the frame 12, and includes various components to facilitate operation of the refuse vehicle 10 by an operator (e.g., a seat, a steering wheel, hydraulic controls, etc.) as well as components that can execute commands automatically to control different subsystems within the vehicle (e.g., computers, controllers, processors, etc.). The refuse vehicle 10 further includes a prime mover 20 coupled to the frame 12 at a position beneath the cab 18. The prime mover 20 provides power to a plurality of motive members, shown as wheels 22, and to other systems of the vehicle (e.g., a pneumatic system, a hydraulic system, etc.). A pair of wheels 22 may be coupled to an axle. The refuse vehicle 10 may include at least two axles. In some embodiments, the refuse vehicle 10 may include at least four axles, and may include five axles in various embodiments herein. The prime mover 20 may be configured to use a variety of fuels (e.g., gasoline, diesel, bio-diesel, ethanol, natural gas, etc.), according to various exemplary embodiments. According to an alternative embodiment, the prime mover 20 includes one or more electric motors coupled to the frame 12. The electric motors may consume electrical power from an on-board storage device (e.g., batteries, ultra-capacitors, etc.), from an on-board generator (e.g., an internal combustion engine, high efficiency solar panels, regenerative braking system, etc.), or from an external power source (e.g., overhead power lines) and provide power to the systems of the refuse vehicle 10. According to some embodiments, the refuse vehicle 10 may be in other configurations than shown in FIG. 1. The refuse vehicle 10 may be in configurations such as a front loader, a side loader, a rear loader, or a curb-sort recycling configuration.

According to an exemplary embodiment, the refuse vehicle 10 is configured to transport refuse from various waste refuse containers within a municipality to a storage or processing facility (e.g., a landfill, an incineration facility, a recycling facility, etc.). In the embodiment of FIG. 1, the body 14 and on-board refuse container 16, in particular, includes a collection chamber 24 and a hopper 26. The collection chamber 24 is defined by a collection chamber first wall 28 (e.g., first wall, second wall, etc.), a collection chamber second wall (e.g., first wall, second wall, etc.), and a collection chamber top wall 30 (e.g., panel, cover, etc.). The hopper 26 is integrally formed with the collection chamber 24. As utilized herein, two or more elements are “integrally formed” with each other when the two or more elements are formed and joined together as part of a single manufacturing process to create a single-piece or unitary construction that cannot be disassembled without an at least partial destruction of the overall component.

The hopper 26 is defined by a hopper first wall 32 (e.g., first wall, second wall, etc.), a hopper second wall (e.g., a first wall, a second wall, etc.), and a hopper top wall 34 (e.g., a panel, a cover, etc.). In some embodiments, the hopper first wall 32 is integrally formed with the collection chamber first wall 28 to form a first refuse container side wall shown as a first wall 36, and the hopper second wall is integrally formed with the collection chamber second wall, so as to form a second wall (e.g., a second refuse container side wall, etc.). The second wall is positioned opposite of the first wall 36. In some embodiments, the hopper top wall 34 is integrally formed with the collection chamber top wall 30 to form a refuse container top wall shown as top wall 38.

In some embodiments, the on-board refuse container 16 is shaped as a generally rectangular box having two transverse upper edges, two longitudinal upper edges, two transverse lower edges, and two longitudinal lower edges. The longitudinal edges extend along the length of the on-board refuse container 16 and the transverse edges extend across the length of the on-board refuse container 16, according to an exemplary embodiment.

The body 14 further includes a tailgate 40 which is movably (e.g., rotatably, etc.) coupled to the on-board refuse container 16 and is positioned at the rear end of the body 14. The tailgate 40 is configured to pivot about pivot pins positioned along the top surface of the on-board refuse container 16. In other embodiments, a different connection mechanism may be used to support the tailgate 40 on the body 14.

According to the embodiment shown in FIG. 1, the on-board refuse container 16, collection chamber 24, and the hopper 26 are each positioned behind the cab 18. In some embodiments, the collection chamber 24 includes a storage volume and the hopper 26 includes a hopper volume. Loose refuse is initially loaded into the hopper volume by a manual (e.g. by hand) or automatic means (e.g., lifting system) and is thereafter compacted into the storage volume. The collection chamber provides temporary storage for refuse during transport to a waste disposal site or a recycling facility. In some embodiments, at least a portion of the on-board refuse container 16 and collection chamber extend over or in front of the cab 18.

According to an exemplary embodiment, the hopper volume is positioned at least partially within the tailgate 40. In other embodiments, the hopper volume is positioned between the storage volume and the cab 18 (i.e., refuse is loaded into a position behind the cab 18 and stored in a position further toward the rear of the refuse vehicle 10).

In some embodiments, the refuse vehicle includes a separate actuator and/or manual latch like assembly to secure the tailgate 40 to the refuse container 16 (e.g., rear body, refuse body, receptacle, etc.) of the refuse vehicle 10. In the embodiment of FIG. 1, the refuse vehicle 10 includes a tailgate actuator assembly, shown as a tailgate actuator 42 (e.g., hydraulic actuator, linear actuator, piston, etc.). The tailgate actuator 42 is configured to move the tailgate 40 about the pivot pins between an open position (e.g., a first tailgate position, etc.), away from the refuse container 16, and a closed position (e.g., a second tailgate position, etc.) in which the tailgate 40 is rotated into engagement with the refuse container 16.

The tailgate actuator 42 is rotatably coupled at a body end (e.g., a first actuator end, etc.) of the tailgate actuator 42 (e.g. first tailgate actuator end, etc.) to the body 14, and coupled (e.g., attached, fixed, welded, fastened, riveted, adhesively attached, bonded, pinned, bolted, screwed, etc.) to the tailgate 40 at a tailgate end (e.g., a second actuator end, etc.) opposite the body end. The tailgate actuator 42 is communicatively coupled to a processing unit shown as a processor 44. The processor 44 is configured to provide signals to selectively actuate the tailgate actuator 42. In some embodiments, the processor 44 monitors the position of the tailgate actuator 42 and the tailgate 40 (e.g., through communication with a position sensor within the tailgate actuator 42 and/or a position sensor within the tailgate 40). In some examples, the processor 44 communicates with a throttle and/or clutch of a vehicle transmission so that the tailgate actuator 42 cannot be deployed or otherwise adjusted outward from the fully-retracted position when the processor 44 receives an indication that the vehicle 10 is traveling over a threshold speed (e.g., 10 mph). In another example, the processor 44 may also receive signals from the sensors (e.g., proximity sensors, cameras, etc.) on the refuse vehicle 10 that indicate an unsafe condition for moving the on-board refuse container 16 towards the fully deployed position. In this example, the processor 44 may prevent adjustment of tailgate actuator 42 outward from the fully-retracted position. In yet other embodiments, the tailgate actuator 42 is controlled via a control level of a tailgate actuator 42 of the refuse vehicle 10.

In some embodiments, the tailgate actuator 42 is controlled from within a central location, such as the cab 18 of the refuse vehicle 10. The cab 18 may include control panel including a series of inputs that can be actuated by a user to perform different operation. The control panel may also be in communication the processor 44 to provide signals and/or commands (e.g., command signals, etc.) that can be subsequently executed by the processor 44.

In some embodiments, the tailgate actuator 42 may include a hydraulic actuator (e.g., a hydraulic cylinder) that is fluidly coupled to a hydraulic pump onboard the refuse vehicle 10. In other embodiments, the tailgate actuator 42 includes an electric actuator (e.g., linear actuator, etc.) and/or another actuator type. In embodiments in which the hydraulic actuator is a hydraulic cylinder, the cylinder may include a sleeve and a piston rod disposed within the sleeve. In operation, the piston rod (e.g., an actuator arm, etc.) extends from the body 14 and out of the sleeve toward the tailgate 40 and causes the tailgate 40 to move upwardly and outwardly from the closed position to the open position. In the open position, the storage volume of the collection chamber 24 may be accessed such that the refuse may be removed therefrom.

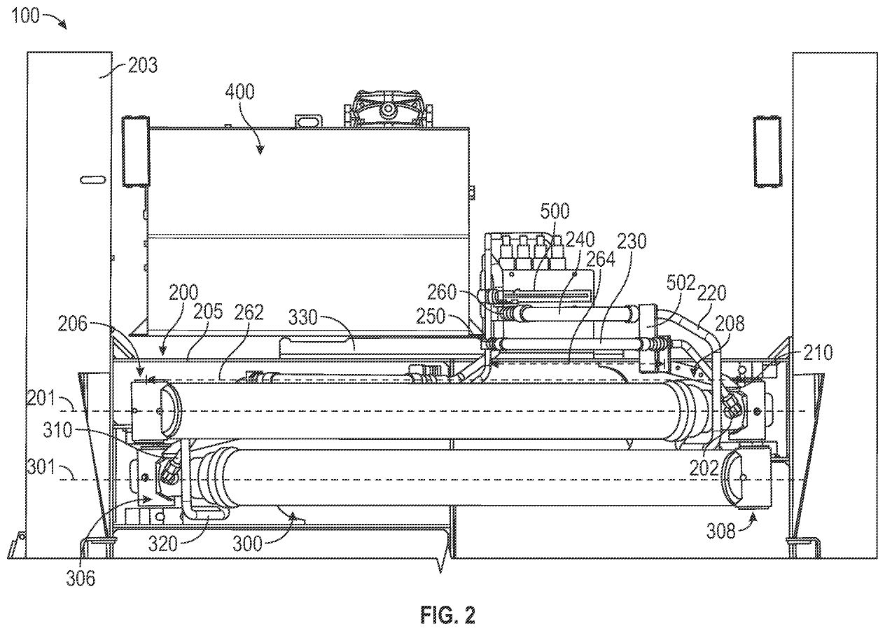

Referring now to FIGS. 2-4, various perspective views of a hydraulic system 100 are shown, according to an example embodiment. The hydraulic system 100 is configured to controllably move (e.g., transform, etc.) a plurality of hydraulic cylinders, including a first hydraulic cylinder 200 and a second hydraulic cylinder 300, between a retracted orientation and an extended orientation. The first hydraulic cylinder 200 and/or the second hydraulic cylinder 300 are movable between the retracted orientation and an extended orientation to control movement a piece of equipment (e.g., a device, a plurality of devices, etc.). For example, the first hydraulic cylinder 200 and/or the second hydraulic cylinder 300 may drive one or more pieces of equipment or devices included on a refuse vehicle (e.g., the refuse vehicle 10).

In the embodiment of FIGS. 2-4, the hydraulic cylinders are configured to move an ejector 203 (e.g., an ejector panel, a packer panel, etc.) relative to a support structure 205 of the refuse vehicle to pack refuse within the storage volume and/or to eject refuse from within the storage volume through a tailgate end of the refuse vehicle, and to an area outside of the refuse vehicle. A first cylinder end of the first hydraulic cylinder 200 and/or the second hydraulic cylinder 300 may be coupled (e.g., pivotally) to the support structure 205 (e.g., to a body of the refuse vehicle that is stationary with respect to a chassis of the refuse vehicle, etc.). A second cylinder end of the first hydraulic cylinder 200 and/or the second hydraulic cylinder 300 may be coupled to the ejector 203.

The first hydraulic cylinder 200 and the second hydraulic cylinder 300 are configured to move the ejector 203 relative to a refuse container of the refuse vehicle between a retracted position, in which the ejector 203 is positioned proximate to a forward wall of the refuse container, and an extended position that is spaced apart from the retracted position (e.g., in which the ejector 203 is positioned adjacent to a rear wall of the refuse container, etc.). In some embodiments, the first hydraulic cylinder 200 and the second hydraulic cylinder 300 are arranged to cross one another as they extend between the support structure of the refuse vehicle and the ejector 203. In such arrangements, the first hydraulic cylinder 200 and the second hydraulic cylinder 300 may form an X-shape when viewed from above.

The first hydraulic cylinder 200 extends along a first axis 201 from a first hydraulic cylinder end 206 to a second hydraulic cylinder end 208. According to various embodiments, the first hydraulic cylinder 200 is configured to move (e.g., transform, etc.) along the first axis 201 between a retracted orientation (e.g., shown in FIG. 2) and an extended orientation. For example, a distance 262 (e.g., an axial distance, etc.) between the first hydraulic cylinder end 206 and the second hydraulic cylinder end 208 may increase as the first hydraulic cylinder 200 moves from the retracted orientation to the extended orientation.

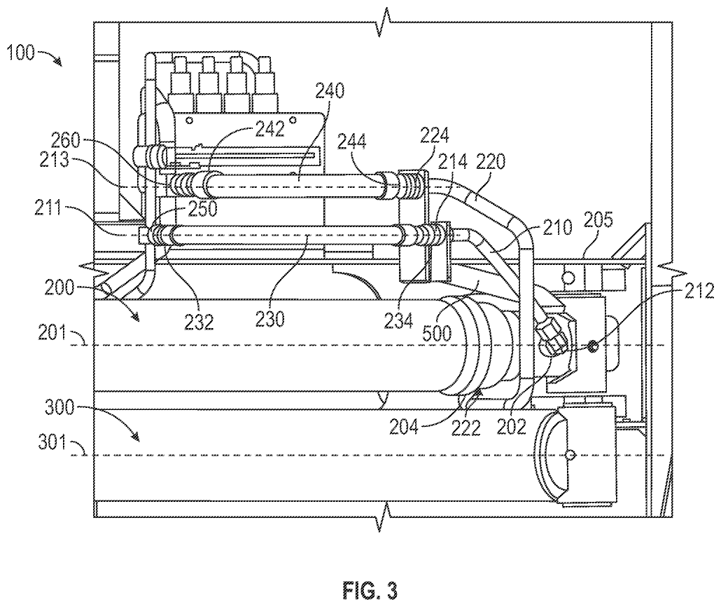

The first hydraulic cylinder 200 includes a first cylinder port 202 (e.g., a first input port, etc.) that is configured to receive pressurized liquid (e.g., hydraulic fluid) from at least one of a pump or a fluid reservoir 400 (see FIG. 2) to actuate the first hydraulic cylinder 200 from the retracted orientation to the extended orientation. Further, the first hydraulic cylinder includes a second cylinder port 204 (e.g., a second input port, etc.) (see FIG. 3), that is configured to release pressurized liquid from within an inner volume to the first hydraulic cylinder 200 (e.g., a sleeve of the first hydraulic cylinder, etc.) to actuate the first hydraulic cylinder 200 from the extended orientation to the retracted orientation.

The first cylinder port 202 is coupled to a first rigid tube 210 (e.g., a first rigid conduit, etc.). As shown in FIG. 3, the first rigid tube 210 extends from a first rigid tube end 212 to a second rigid tube end 214. As shown, the first rigid tube end 212 is coupled to and in fluid communication with the first cylinder port 202. For example, hydraulic fluid from the fluid reservoir 400 and/or the pump may be provided to the first cylinder port 202 via the first rigid tube 210. The first rigid tube 210 may be formed of a rigid material, such as a metal, a hardened plastic, etc. The rigid material may substantially maintain shape and structure as the first hydraulic cylinder 200 moves between the retracted orientation and the extended orientation. As discussed further herein, the first rigid tube 210 is orientated such that a first flexible tube 230 (e.g., a first flexible conduit, a first flexible hose, etc.) coupled to the second rigid tube end 214 remains substantially within a first reference plane, shown as a first plane 211, as the first hydraulic cylinder 200 moves between the retracted orientation and the extended orientation. According to various embodiments, such an arrangement can reduce and/or eliminate any off-axis forces experienced at the connecting points (e.g., proximate a first flexible tube end 232 and a second flexible tube end 234), thereby reducing the likelihood of leaks occurring proximate the connection points. Such an arrangement can also reduce any torque on the flexible tube, which can increase the service life of the flexible tube before the flexible tube needs to be replaced. As shown, the second rigid tube end 214 is supported by a support 502 that is coupled to an extends from the first hydraulic cylinder 200, which may facilitate keeping the first rigid tube 210 in a desired shape and orientation as the first hydraulic cylinder 200 moves between the retracted orientation and the extended orientation.

As shown in FIG. 3, the first flexible tube 230 extends from a first flexible tube end 232 to a second flexible tube end 234. The first flexible tube end 232 is coupled to a first fluid port 250 (e.g., a fluid input, a fluid output, etc.) and is configured to fluidly couple the first fluid port 250 to the first flexible tube 230. In some embodiments, the first flexible tube end 232 is configured to provide fluid to the first flexible tube 230. As shown in FIG. 3, the first plane 211 is intersected by the first fluid port 250, the first flexible tube end 232, the second flexible tube end 234, and the second rigid tube end 214. Further, the first plane 211 is intersected by the first flexible tube 230 along substantially an entire length of the first flexible tube 230. In some embodiments, a central axis 231 of the first flexible tube 230 extends along the first plane 211 at all positions between the retracted orientation and the extended orientation.

As the first hydraulic cylinder 200 moves from the retreated orientation (shown in FIG. 2) to the extended orientation, a distance 264 between the first fluid port 250 and the second rigid tube end 214 increases. Due to the additional length and/or slack of the first flexible tube 230, the first flexible tube 230 remains coupled to the first fluid port 250 and the second rigid tube end 214 as the first hydraulic cylinder 200 moves. As the first hydraulic cylinder 200 moves to the extended orientation, the first fluid port 250 and the second rigid tube end 214 both remain substantially within the first plane 211 (so that the first plane 211 passes through both the first fluid port 250 and the second rigid tube end 214, so that opposing ends of the first flexible tube 230 remain are intersected by the first plane 211, etc.) due to the shape and orientation of the first rigid tube 210, which can reduce the off-axis forces experienced at the connection points. Further, the first flexible tube 230 may substantially remain in the first plane 211 (e.g., along at least 80% of the flexible tube, etc.) as the first hydraulic cylinder 200 transforms between the retracted orientation and the extended orientation. According to various embodiments, the first plane 211 is parallel to the first axis 201 and/or the second axis 301.

The first hydraulic cylinder 200 includes a second cylinder port 204 (e.g., a second input port, etc.). In some embodiments, the second cylinder port 204 is configured to receive pressurized liquid (e.g., hydraulic fluid) from the inner volume of the first hydraulic cylinder 200 and provide the liquid to at least one of a pump or a fluid reservoir 400 (see FIG. 2) to actuate the first hydraulic cylinder 200 from the extended orientation to the retracted orientation.

The second cylinder port 204 is coupled to a second rigid tube 220 (e.g., a second rigid conduit, etc.). As shown in FIG. 3, the second rigid tube 220 extends from a third rigid tube end 222 to a fourth rigid tube end 224. As shown, the third rigid tube end 222 is coupled to and in fluid communication with the second cylinder port 204. For example, hydraulic fluid from the fluid reservoir 400 may be received from the second cylinder port 204 via the second rigid tube 220. The second rigid tube 220 may be formed of a rigid material, such as a metal, a hardened plastic, etc. The rigid material may substantially maintain shape and structure as the first hydraulic cylinder 200 transforms between the retracted orientation and the extended orientation. As discussed further herein, the second rigid tube 220 is oriented such that a second flexible tube 240 (e.g., a second flexible conduit, etc.) coupled to the fourth rigid tube end 224 remains substantially within a second reference plane, shown as second plane 213, as the first hydraulic cylinder 200 moves between the retracted orientation and the extended orientation. According to various embodiments, such an arrangement can reduce the off-axis forces experienced at the connecting points (e.g., proximate a first flexible tube end 232 and a fourth flexible tube end 244), thereby reducing the likelihood of leaks occurring proximate the connection points. As shown, the fourth rigid tube end 224 is supported by a support 502 that extends between the first hydraulic cylinder 200 and the second rigid tube end 214, which may facilitate keeping the second rigid tube 220 in a desired shape and orientation as the first hydraulic cylinder 200 moves between the retracted orientation and the extended orientation.

As shown in FIG. 3, the second flexible tube 240 extends from a third flexible tube end 242 to a fourth flexible tube end 244. The third flexible tube end 242 is coupled to a second fluid port 260 (e.g., a second input port, etc.). In some embodiments, the third flexible tube end 242 is configured to provide fluid from the second fluid port 260 to the second flexible tube 240. As shown in FIG. 3, the second plane 213 is intersected by the second fluid port 260, the third flexible tube end 242, the second flexible tube end 234, and the fourth rigid tube end 224. Further, the second plane 213 is intersected by the second flexible tube 240. As the first hydraulic cylinder 200 moves from the retreated orientation shown in FIG. 2 to the extended orientation, a distance between the second fluid port 260 and the fourth rigid tube end 224 increases. Due to the additional length and/or slack of the second flexible tube 240, the second flexible tube 240 remains coupled to the second fluid port 260 and the fourth rigid tube end 224 as the first hydraulic cylinder 200 moves. As the first hydraulic cylinder 200 moves to the extended orientation, the second fluid port 260 and the fourth rigid tube end 224 remain in the second plane 213 due to the shape and orientation of the second rigid tube 220, which can reduce the off-axis forces experienced at the connection points. Further, the first flexible tube 230 may substantially remain in the second plane 213 (e.g., at least 80% of the flexible tube remains in the second plane 213) as the first hydraulic cylinder 200 moves between the retracted orientation and the extended orientation. According to various embodiments, the second plane 213 is parallel to the first plane 211, the first axis 201, and/or the second axis 301.

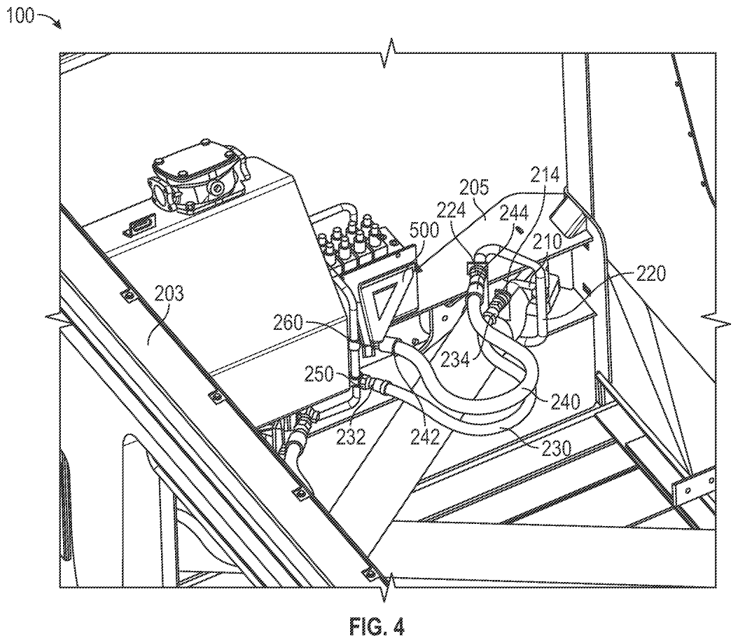

As shown in FIG. 4, the second flexible tube 240 is supported by a support 500 proximate the second fluid port 260, which may facilitate keeping the second flexible tube 240 in the second plane 213 as the first hydraulic cylinder 200 transforms between the retracted orientation and the extended orientation. In some embodiments, the support 500 and the support 502 may form part of the same support structure that extends from the first hydraulic cylinder 200, such as proximate to an end of the first hydraulic cylinder 200.

Referring to FIGS. 2-3, the second hydraulic cylinder 300 (e.g., the second hydraulic actuator, etc.) extends along the second axis 301 from a third hydraulic cylinder end 306 to a fourth hydraulic cylinder end 308. The second hydraulic cylinder 300 similarly includes a first cylinder port (e.g., a first input port, etc.) and a second cylinder port (e.g., a second input port, etc.). Further, a first rigid tube 310 is coupled to the first cylinder port and a second rigid tube 320 is coupled to the second cylinder port. The first rigid tube 310 and the second rigid tube 320 each support a flexible conduit (e.g., the flexible tube 330) such that the flexible tube remains substantially in the second plane 213 as the second hydraulic cylinder 300 moves from the retracted orientation to the extended orientation.

In some embodiments, the flexible tubes for each of the first hydraulic cylinder 200 and the second hydraulic cylinder 300 extend substantially parallel to one another, and remain substantially parallel to one another during actuation of the first hydraulic cylinder 200 and the second hydraulic cylinder 300. It should be understood that the number of connections and flexible/rigid tubes may be different in various embodiments. In other embodiments, the first hydraulic cylinder 200 and/or the second hydraulic cylinder 300 may be used to power different devices of the refuse vehicle.

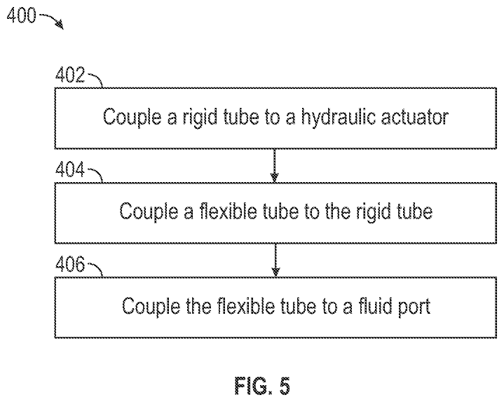

Referring to FIG. 5, a method 400 of manufacturing a hydraulic system is shown, such as the hydraulic system 100 of FIGS. 2-4, according to an embodiment. At 402, a first rigid tube is coupled to a hydraulic actuator. In some embodiments, operation 402 includes coupling a first rigid tube end of the rigid tube to a hydraulic actuator that is configured to move relative to a support structure between a retracted orientation and an extended orientation. In some embodiments, operation 402 includes coupling a support structure (e.g., a support) that is fixedly coupled to the hydraulic actuator and extends away from the hydraulic actuator to the rigid tube (e.g., proximate to the second rigid tube end of the rigid tube, etc.).

At 404, a first flexible tube is coupled to the rigid tube. In some embodiments, operation 404 includes coupling a first flexible tube end of the flexible tube to a second rigid tube end of the rigid tube. The flexible tube may be supported by the rigid tube so that the flexible tube extends substantially along a single reference plane as the hydraulic actuator moves from the retracted orientation to the extended orientation.

At 406, the flexible tube is coupled to a fluid port. In some embodiments, operation 406 includes coupling a second flexible tube end of the flexible tube to a fluid port that is coupled to the support structure so that the rigid tube moves relative to the fluid port between the retracted orientation and the extended orientation, and so that the second rigid tube end and the fluid port are disposed along the same reference plane when the hydraulic actuator is in both the retracted orientation and the extended orientation. In some embodiments, operation 406 includes orienting the flexible tube so that the flexible tube (e.g., a central axis of the flexible tube, etc.) extends substantially along the reference plane.

In some embodiments, the method further includes coupling a second rigid tube and a second flexible tube to the hydraulic cylinder to fluidly couple a second fluid port to the hydraulic cylinder in a similar method as described with respect to fluidly coupling the first fluid port to the hydraulic cylinder. In some embodiments, fluidly coupling the second flexible tube to the hydraulic cylinder includes orientating the second flexible tube along a second reference plane that is substantially parallel to the first reference plane.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” etc.) are merely used to describe the orientation of various elements in the figures. It should be noted that the orientation of various elements may differ according to other exemplary embodiments, and that such variations are intended to be encompassed by the present disclosure.

References herein to the positions of elements (e.g., “first”, “second”, “third”, etc.,) are used to distinguish one element from another element without necessarily requiring or implying any actual such relationship or order. It should be noted that the orientation of various elements may differ according to other exemplary embodiments, and that such variations are intended to be encompassed by the present disclosure.

It is important to note that the construction and arrangement of the refuse vehicle as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present disclosures. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A hydraulic system comprising:
a support structure;
a hydraulic actuator, at least a portion of the hydraulic actuator movable between a retracted orientation and an extended orientation relative to the support structure;
a rigid tube extending from a first rigid tube end to a second rigid tube end, the first rigid tube end coupled to the hydraulic actuator;
a flexible tube extending from a first flexible tube end to a second flexible tube end, the second flexible tube end being coupled to the rigid tube at the second rigid tube end; and
a fluid port coupled to the support structure so that the rigid tube moves relative to the fluid port between the retracted orientation and the extended orientation, the fluid port coupled to the second flexible tube end so that the second rigid tube end and the fluid port are disposed along the same reference plane when the hydraulic actuator is in both the retracted orientation and the extended orientation.

2. The hydraulic system of claim 1, wherein the flexible tube extends substantially along the reference plane as the hydraulic actuator moves from the retracted orientation to the extended orientation.

3. The hydraulic system of claim 2, wherein a distance between the second rigid tube end and the fluid port changes as the hydraulic actuator moves from the retracted orientation to the extended orientation.

4. The hydraulic system of claim 1, wherein the hydraulic actuator extends along a first axis between a first actuator end and a second actuator end, and wherein the reference plane is oriented substantially parallel to the first axis.

5. The hydraulic system of claim 1, wherein a first distance between the second rigid tube end and the fluid port is defined while the hydraulic actuator is in the retracted orientation and a second distance between the second rigid tube end and the fluid port is defined while the hydraulic actuator is in the extended orientation, the second distance being different from the first distance.

6. The hydraulic system of claim 5, wherein the second distance is greater than the first distance.

7. The hydraulic system of claim 1, further comprising a first rigid support extending from the second rigid tube end to the hydraulic actuator.

8. The hydraulic system of claim 1, wherein the hydraulic actuator is a first hydraulic actuator, the rigid tube is a first rigid tube, the flexible tube is a first flexible tube, the fluid port is a first fluid port, and the reference plane is a first reference plane, the hydraulic system further comprising:
a second hydraulic actuator having a first actuator portion configured to move between the retracted orientation and the extended orientation, the hydraulic actuator including a second cylinder port;
a second rigid tube extending from a third rigid tube end to a fourth rigid tube end, the third rigid tube end coupled to the second hydraulic actuator;
a second flexible tube extending from a third flexible tube end to a fourth flexible tube end, the fourth flexible tube end being coupled to the second rigid tube at the fourth rigid tube end; and
a second fluid port coupled to the support structure so that the second rigid tube moves relative to the fluid port between the retracted orientation and the extended orientation, the second fluid port coupled to the third flexible tube end so that the fourth rigid tube end and the second fluid port are disposed along a second reference plane when the hydraulic actuator is in both the retracted orientation and the extended orientation.

9. The hydraulic system of claim 8, wherein the second reference plane is substantially parallel to the first reference plane.

10. The hydraulic system of claim 1, wherein the hydraulic actuator is configured to drive one or more components of a refuse vehicle.

11. A refuse vehicle comprising:
a body defining a refuse container;
a device coupled to the body;
a hydraulic actuator coupled to the device and configured to move the device relative to the refuse container between a retracted position and an extended position;
a rigid tube fluidly coupled to the hydraulic actuator and movable relative to the body between the retracted position and the extended position; and
a flexible tube extending from the rigid tube to a fluid port on the body, the rigid tube arranged to support the flexible tube so that the flexible tube extends substantially along the same reference plane as the device moves from the retracted position to the extended position.

12. The refuse vehicle of claim 11, wherein a distance between the rigid tube and the fluid port changes as the hydraulic actuator extends from the retracted position to the extended position.

13. The refuse vehicle of claim 11, wherein the hydraulic actuator extends along a first axis between a first hydraulic actuator end and a second hydraulic actuator end, and wherein the reference plane is oriented substantially parallel to the first axis.

14. The refuse vehicle of claim 11, further comprising a first rigid support extending from the rigid tube to the hydraulic actuator.

15. The refuse vehicle of claim 11, wherein the hydraulic actuator is a first hydraulic actuator, the rigid tube is a first rigid tube, the flexible tube is a first flexible tube, the fluid port is a first fluid port, and the reference plane is a first reference plane, the refuse vehicle further comprising:
a second hydraulic actuator that is coupled to the device and configured to move the device relative to the refuse container between the retracted position and the extended position;
a second rigid tube fluidly coupled to the hydraulic actuator; and
a second flexible tube extending from the second rigid tube to a second fluid port on the body, the second rigid tube arranged to support the second flexible tube so that the second flexible tube extends substantially along a second reference plane as the device moves from the retracted position to the extended position.

16. The refuse vehicle of claim 15, wherein the second reference plane is substantially parallel to the first reference plane.

17. The refuse vehicle of claim 11, wherein the device is an ejector that is disposed within the refuse container and configured to move refuse relative to the refuse container.

18. A method comprising:
coupling a first rigid tube end of a rigid tube to a hydraulic actuator that is configured to move relative to a support structure between a retracted orientation and an extended orientation;
coupling a first flexible tube end of a flexible tube to a second rigid tube end of the rigid tube; and
coupling a second flexible tube end of the flexible tube to a fluid port that is coupled to the support structure so that the rigid tube moves relative to the fluid port between the retracted orientation and the extended orientation, and so that the second rigid tube end and the fluid port are disposed along the same reference plane when the hydraulic actuator is in both the retracted orientation and the extended orientation.

19. The method of claim 18, wherein the flexible tube is supported by the rigid tube so that the flexible tube extends substantially along the reference plane as the hydraulic actuator moves from the retracted orientation to the extended orientation.

20. The method of claim 18, wherein coupling the second flexible tube end of the flexible tube to the fluid port comprises orienting the flexible tube so that the flexible tube extends substantially along the reference plane.
